(19) United States
(12) Patent Application Publication
(10) Pub. No.: US 2012/0221365 A1
(43) Pub. Date: Aug. 30, 2012

(54) INFORMATION PROCESSING SYSTEM, APPARATUS, METHOD, STORAGE MEDIUM

(76) Inventor: Hiroshi MAEDA, Kanagawa (JP)

(21) Appl. No.: 13/402,375

(22) Filed: Feb. 22, 2012

(30) Foreign Application Priority Data
Feb. 28, 2011 (JP) 2011-041921
Nov. 14, 2011 (JP) 2011-248716

(51) Int. Cl. G06F 15/173; G06Q 10/06

(52) U.S. Cl. 705/7.11; 709/225

(57) ABSTRACT

An information processing apparatus which provides minutes-of-meeting information corresponding to a request for minutes of a meeting, including: an importance level evaluation unit which evaluates a first importance level corresponding to a user who requests browsing of the minutes of the meeting.

### CROSS-REFERENCE TO RELATED APPLICATIONS

The present application claims priority under 35 U.S.C. §119(a) to and incorporates by reference the entire contents of Japanese Patent Application No. 2011-041921 filed in Japan on Feb. 28, 2011 and Japanese Patent Application No. 2011-248716 filed in Japan on Nov. 14, 2011.

### BACKGROUND OF THE INVENTION

1. Field of the Invention

The present invention relates to management of minutes of a meeting, specifically relates to an information processing system, a server, a method, a storage medium, which extracts necessary information from minutes of a meeting.

2. Description of the Related Art

Conventionally, it has been suggested that a meeting system can be used to create and manage minutes of a wide variety of meetings held in companies and government offices.

For example, Japanese Patent Application Laid-open No. 2008-140089 describes a meeting system which extracts from the minutes of a meeting an assignment content for actions that anyone who was associated with the meeting needs to respond to (i.e., an action item) and which manages the assignment content.

The '089 meeting system determines whether an action item is included in character string data which composes the minutes of a meeting.

In the case in which the meeting system determines that an action item is included in character string data which composes the minutes of the meeting, the '089 meeting system extracts a personal name from the character string data and registers the personal name as the person assigned to the action item.

Alternatively, in the case in which the meeting system determines that the action item is included in character string data which composes the minutes of the meeting, the '089 meeting system registers a leader of a task as the person assigned to the action item.

In this way, the '089 meeting system manages the action items.

### SUMMARY OF THE INVENTION

In one embodiment of the invention, there is provided an information processing apparatus which provides minutes-of-meeting information corresponding to a request for minutes of a meeting. The information processing apparatus includes an importance level evaluation unit which evaluates a first importance level corresponding to a user who requests browsing of the minutes of the meeting.

In one embodiment of the invention, there is provided an information processing method for providing minutes-of meeting-information corresponding to a request for minutes of a meeting. The method evaluates a first importance level corresponding to a user who requests browsing of the minutes of meeting.

In one embodiment of the invention, there is provided an information processing apparatus. The apparatus includes means for providing minutes-of-meeting information corresponding to a request for minutes of a meeting. The apparatus includes means for evaluating a first importance level corresponding to a user who requests browsing of the minutes of meeting.

It is to be understood that both the foregoing general description of the invention and the following detailed description are exemplary, but are not restrictive of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a diagram illustrating an information processing system according to a first embodiment of the present invention;

FIG. 2 is a block diagram of a minutes-of-a=meeting server according to this embodiment of the present invention;

FIG. 3 is a flowchart illustrating process executed by the minutes-of-a-meeting server according to this embodiment of the present invention;

FIG. 4 is a diagram illustrating a minutes-of-a-meeting information table in which the minutes-of-a-meeting information is registered according to this embodiment of the present invention;

FIG. 5 is a diagram illustrating a weighted coefficient information table according to this embodiment of the present invention;

FIG. 6 is a diagram illustrating an office organization information table in which office organization information is registered according to this embodiment of the present invention;

FIG. 7 is a diagram illustrating a browse-information displaying screen which is displayed on a display unit of the information processing apparatus according to this embodiment of the present invention;

FIG. 8 is a flowchart illustrating a process executed by the minutes-of-a-meeting server according to a second embodiment of the present invention;

FIG. 9 is a diagram illustrating a minutes-of-a-meeting information table in which the minutes-of-meeting information is registered according to the second embodiment of the present invention;

FIG. 10 is a diagram illustrating a minutes-of-a-meeting information table in which the minutes-of-meeting information is registered according to a third embodiment of the present invention;

FIG. 11 is a diagram illustrating a weighted coefficient information table according to the third embodiment of the present invention;

FIG. 12 is a diagram illustrating an office organization information table in which office organization information is registered according to a fourth embodiment of the present invention;

FIG. 13 is a diagram illustrating an office organization information table in which office organization information is registered according to a fifth embodiment of the present invention;

FIG. 14 is a diagram illustrating a weighted coefficient information table according to the fifth embodiment of the present invention;

FIG. 15 is a diagram illustrating an office organization information table in which office organization information is registered according to a sixth embodiment of the present invention;

FIG. 16 is a diagram illustrating a weighted coefficient information table according to the sixth embodiment of the present invention;

FIG. 17 is a diagram illustrating a weighted coefficient information table according to a seventh embodiment of the present invention;

FIG. 18 is a diagram illustrating an information processing system according to an eighth embodiment of the present invention;

FIG. 19 is a block diagram of a minutes-of-a-meeting server according to the eighth embodiment of the present invention;

FIG. 20 is a diagram illustrating a minutes-of-a-meeting information table in which the minutes-of-meeting information is registered according to the eighth embodiment of the present invention;

### DETAILED DESCRIPTION

Hereinafter, exemplary embodiments of the present invention will be described with reference to the accompanying drawings. But, the present invention is not limited to the embodiments, and variations and modifications may be made without departing from the basic concepts of the present invention as claimed.

With reference to the '089 meeting system which extracts the task included in the minutes of a meeting from a only viewpoint of response accountability, this meeting system can not extract the task included in the minutes of the meeting from the viewpoint of another person. Accordingly, a person browsing (a browser) who is not a person responsible for the task can not extract contents of minutes of the meeting related to the browser from the minutes of the meeting.

The present invention was made in view of this problem.

The present invention provides an information processing system, a server, a method, and/or a storage medium which makes a person such as the browser who requests to browse the minutes of the meeting to have the capability to extract the minutes of the meeting related to himself or herself.

A server included in the information processing system evaluates an importance level corresponding to a user such as the browser by applying weighted coefficient(s) to the minutes of the meeting.

The server in one embodiment provides the importance level and the minutes of the meeting to an information processing apparatus which requests to browse the minutes of the meeting. Thus, the user who requests browsing the minutes of the meeting can extract from the minutes of the meeting information related to the user.

In addition, this invention provides in various embodiments a method and/or a storage medium which makes a user (such as the browser who requests to browse the minutes of the meeting) able to extract from the minutes of the meeting information related to the user.

### First Embodiment

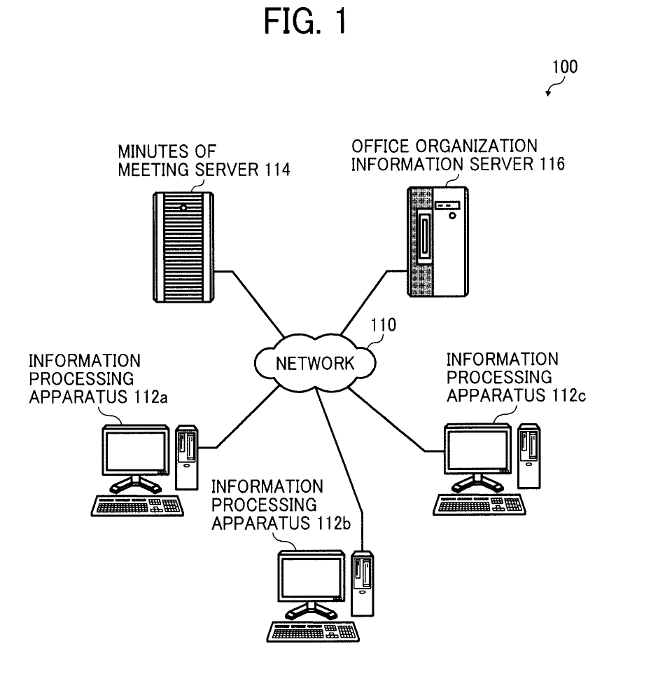

FIG. 1 is a diagram illustrating a information processing system according to one embodiment of the present invention. The information processing system 100 includes information processing apparatuses 112a,112b,112c connected to a network 110, a minutes-of-a-meeting server 114, and an office organization information server 116.

The network 110 can be composed as a network which is using TCP/IP protocol and SOAP protocol and so on. For example, network 110 can be composed of public network such as Internet, wide area network (WAN), and/or local area net work (LAN). Network 110 can utilize ether net accordingly.

In one aspect of this embodiment, the information processing apparatuses 112a, 112b, 112c is utilized for browsing the minutes of the meeting. The information processing apparatuses 112a, 112b, 112c sends browse request to the minutes-of-meeting server 114 based on a direction of a user who demands browsing the minutes of a meeting. The information processing apparatuses 112a, 112b, 112c can display, on the display unit of the information processing apparatus, the minutes of the meeting received from the minutes-of-meeting server 114.

In one aspect of this embodiment, the information processing apparatuses 112a, 112b, 112c are implemented with information processing apparatuses such as a notebook personal computer, a desktop personal computer or a wireless movable terminal. The wireless movable terminal can be for example a smart phone or a personal digital assistant (PDA)

The minutes-of-meeting server 114 processes the minutes-of-meeting information. The minutes-of-meeting server 114 can receive the minutes-of-meeting information from an administration terminal or the information processing apparatus 112a, 112b, 112c. The minutes-of-meeting server 114 registers the minutes-of-meeting information in a storage apparatus which is accessible from the minutes-of-meeting server 114.

In one aspect of this embodiment, the minutes-of-meeting server 114 receives a browse request to browse the minutes-of-meeting information from the information processing apparatus 112a, 112b, 112c.

When the minutes-of-meeting server 114 receives the browse request, the minutes-of-meeting server evaluates an importance level of comments included in the minutes-of-meeting information based on a relation between the minutes-of-meeting information stored in the storage apparatus and the user who requested the browse request. The minutes-of-meeting server sends the minutes-of-meeting information and the importance level.

The minutes-of-meeting server 114 can be loaded with PENTIUM™ processor or a compatible processor. The minutes-of-meeting server 114 can execute programs of this embodiment under the supervision of an operation system (OS). The operation system (OS) can be for example WINDOWS™ series such as WINDOWS XP™, WINDOWS Vista™, WINDOWS 7™, WINDOWS™ server, or MAC™ OS ,or UNIX™ LINUX™. The programs included in the operating system can be programmed with instruction in a programming language such as for example assembler language, C language, C++ language, JAVA™ language, JAVA™ script, PERL™ language, RUBY™ language, or PYTHON™ language.

Further, in one aspect of this embodiment, the minutes-of-meeting server 114 is loaded with a random access memory (RAM) providing execution space for executing the programs and/or a hard disc drive (HDD) for storing the programs and data. The minutes-of-meeting server 114 realizes the functions of this embodiment on the minutes-of-meeting server 114 based on executing the programs.

The office organization information server 116 provides to the minutes-of-meeting server 114 information of an office organization, identifying which group a user belongs to. The office organization information server 116 can receive the office organization information from an administration terminal or the information processing apparatus 112a, 112b, 112c. The office organization information server 116 registers thee office organization information in a storage apparatus which is accessible from the office organization information server 116.

The office organization information server 116 provides the office organization information stored in the storage apparatus by request from the minutes-of-meeting server 114. The office organization information server 116 is loaded with PENTIUM™ processor or a compatible processor. The office organization information server 116 executes programs of this embodiment under the supervision of an operation system (OS). The operation system (OS) can be for example one such as WINDOWS™ series such as WINDOWS XP™, WINDOWS Vista™, WINDOWS 7™, WINDOWS™ server, or MAC™ OS, UNIX™, LINUX™. The programs included in the operating system can be programmed with instruction in with program language such as assembler language, C language, C++ language, Java™ language, Java™ script, PERL language, RUBY language, PYTHON language.

Further, in one aspect of this embodiment, the office organization information server 116 is loaded with a random access memory (RAM) providing execution space for executing the programs, a hard disc drive (HDD) for storing the programs and data. The office organization information server 116 can realize the functions of this embodiment on the office organization information server 116 based on executing the programs.

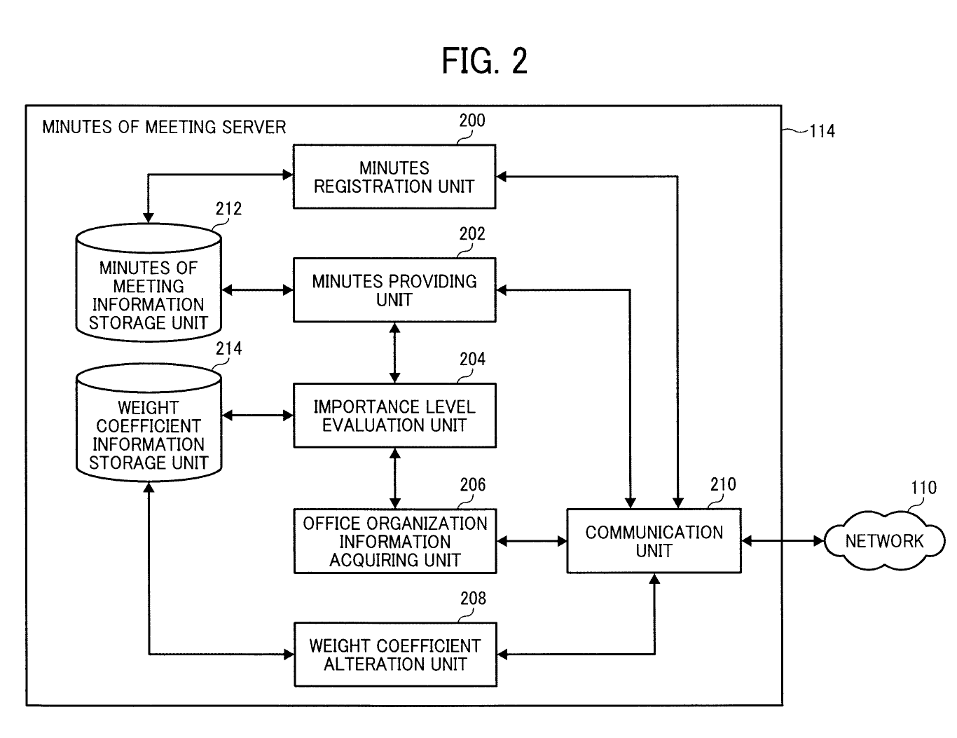

FIG. 2 is a block diagram of the minutes-of-meeting server 114 according to this embodiment of the present invention. With reference to FIG. 2, functions of the minutes-of-meeting server 114 is described below.

The minutes-of-meeting server 114 includes a minutes registration unit 200, a minutes providing unit 202, an importance level evaluation unit 204, an office organization information acquiring unit 206, a weighted coefficient alteration unit 208, a communication unit 210, a minutes-of-meeting information storage unit 212, and a weighted coefficient information storage unit 214.

The minutes registration unit 200 registers the minutes-of-meeting information in the minutes-of-meeting information storage unit 212.

The minutes registration unit 200 receives a registration request of the minutes-of-meeting information and the minutes-of-meeting information from the information processing apparatus 112a, 112b, 112c or the administration terminal through the communication unit 210. When the minutes registration unit 200 receives a registration request of the minutes-of-meeting information, the minutes registration unit 200 registers the registration request and the minutes-of-meeting information in the minutes registration unit 200.

The minutes providing unit 202 provides the minutes-of-meeting information, stored in the minutes-of-meeting information storage unit 212, with the importance level of comments included in the minutes-of-meeting information. The minutes providing unit 202 receives a browse request of the minutes-of-meeting information from the information processing apparatus 112a, 112b, 112c through the communication unit 210.

When the minutes providing unit 202 receives a browse request to browse the minutes-of-meeting information, the minutes providing unit 202 makes the importance level evaluation unit 204 calculate the importance levels of each comment included in the minutes-of-meeting information.

Further, the minutes providing unit 202 generates browse information based on the minutes-of-meeting information and the importance level of comments included in the minutes-of-meeting information. The browse information is used for displaying a browse information display screen.

The minutes providing unit 202 provides upon request the browse information to the information processing apparatus.

In another aspect of this embodiment, the minutes providing unit 202 upon request can provide the minutes-of-meeting information and the importance level of comments included in the minutes-of-meeting information to the information processing apparatus.

The importance level evaluation unit 204 evaluates the importance level of the minutes-of-meeting information stored in the minutes-of-meeting information storage unit 212. When the minutes providing unit 202 calls importance level evaluation unit 204, the importance level evaluation unit 204 makes the office organization information acquiring unit 206 acquire the minutes-of-meeting information from the office organization information server 116. The importance level evaluation unit 204 evaluates the importance level of the comments corresponding to a user who transmitted the browse request, based on the office organization information user identification information transmitted from the information processing apparatuses 112a, 112b, 112c and a weighted coefficient information stored in the weighted coefficient information storage unit 214. The user identification information is information which can distinguish a user.

The office organization information acquiring unit 206 acquires the office organization information from the office organization information server 116. When the importance level evaluation unit 204 calls the office organization information acquiring unit 206, the office organization information acquiring unit 206 requests the office organization information to the office organization information server 116 through the communication unit 210. The office organization information acquiring unit 206 provides, to the importance level evaluation unit 204, the office organization information acquired from the office organization information server 116.

The weighted coefficient alteration unit 208 registers the weighted coefficient information in the weighted coefficient information storage unit 214 and modifies the weighted coefficient information registered in the weighted coefficient information storage unit 214. The weighted coefficient alteration unit 208 receives, through the communication unit 210, a registration request or an alteration request with the weighted coefficient information from the information processing apparatuses 112a, 112b, 112c or administration terminal. When the weighted coefficient alteration unit 208 receives the registration request or the alteration request, the weighted coefficient alteration unit 208 registers the weighted coefficient information in weighted coefficient information storage unit 214.

The communication unit 210 executes data communication between the minutes-of-meeting server 114 and the information processing apparatuses 112a, 112b, 112c or between the minutes-of-meeting server 114 and the office organization information server 116. The communication unit 210 executes a sending of the data and a receiving of the data between each function unit in the minutes-of-meeting server 114 and the information processing apparatuses 112a, 112b, 112c or between the minutes-of-meeting server 114 and the office organization information server 116 based on the type of the request. For example, the communication unit 210 executes the sending and the receiving of data such as the minutes-of-meeting information, the weighted coefficient information, the office organization information, and/or the browse information.

In one aspect of this embodiment, the communication unit 210 can send and receive structured documents includes the minutes-of-meeting information, the office organization information, the weighted coefficient information, and/or the browse information as a simple object access protocol (SOAP) message. The structured documents can be described with a markup language such as HTML, XML, XHTML. In one aspect of this embodiment, the communication unit 210 sends and receives the minutes-of-meeting information, the office organization information, the weighted coefficient information, or the browse information, described in CSV format, as hypertext transfer protocol (HTTP) message. In one aspect of this embodiment, the communication unit 210 can send and receive this information with protocols other than the above-noted protocols.

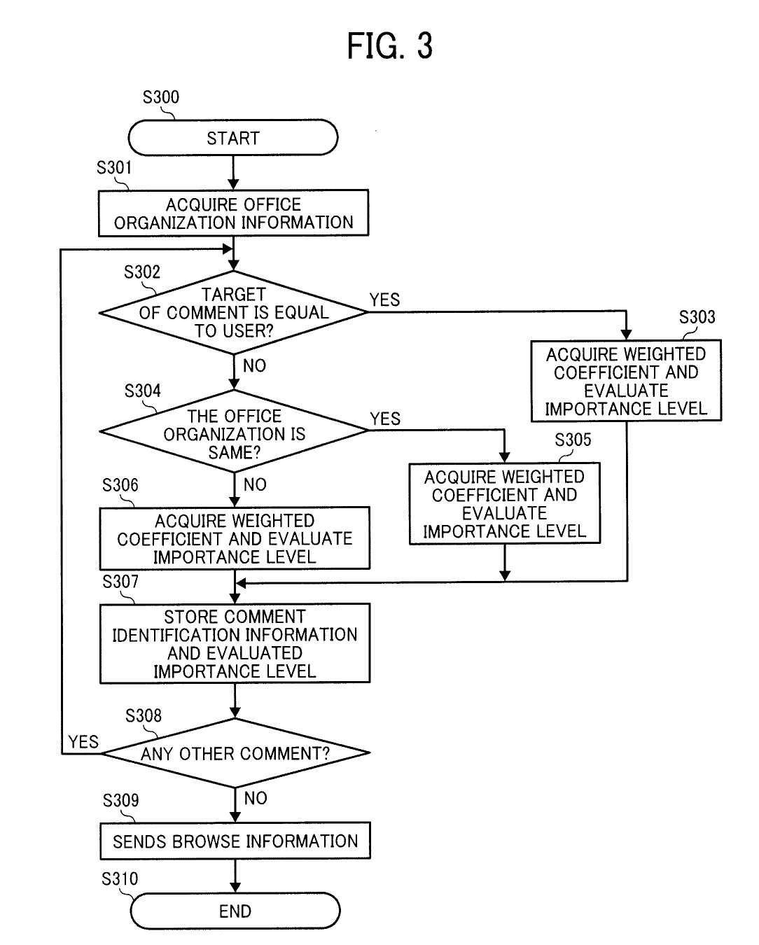

FIG. 3 is a flowchart illustrating process executed by the minutes-of-meeting server according to this embodiment of the present invention. With reference to FIG. 3, the process executed by the minutes-of-meeting server will be described in below.

The process illustrated in FIG. 3 starts with that the communication unit 210 in the minutes-of-meeting server 114 receives the browse request of the minutes-of-meeting information from the information processing apparatus 112a, 112b, 112c in step S300. In step S301, the minutes providing unit 202 receives the browse request from the communication unit 210 and providing unit 202 calls the importance level evaluation unit 204. Further, in step S301, the importance level evaluation unit 204 calls the office organization information acquiring unit 206 and makes office organization information acquiring unit 206 acquire the office organization information from the office organization information server 116.

In step 302, the minutes providing unit 202 determines whether a target identification information identifying a target (e.g. an intended recipient) of the comment included in the minutes-of-meeting information is equal to the user identification information included in the browse request, with reference to the minutes-of-meeting information storage unit 212. The minutes providing unit 202 determines whether the target is equal to the user.

When the minutes providing unit 202 determines the target is equal to the user (YES), the minutes providing unit 202 advances to step S303. In the step S303, the minutes providing unit 202 calls the importance level evaluation unit 204. Next, the importance level evaluation unit 204 acquires the weighted coefficient information from the weighted coefficient information storage unit 214. The importance level evaluation unit 204 evaluates a weighted value, included in the weighted coefficient information, corresponding to the comment directed at the user as to the importance level of the comment.

On the other hand, when the minutes providing unit 202 determines the target is not equal to the user (NO), the minutes providing unit 202 advances to step S304.

In step S304, the minutes providing unit 202 acquires the office organization of the user with reference to the office organization information acquired in step S301, based on the user identification information, and the minutes providing unit 202 acquires the office organization of the target with reference to the office organization information acquired in step S301, based on the target identification information. The minutes providing unit 202 determines whether the office organization which the user belongs to is equal to the office organization which the target belongs to.

When the minutes providing unit 202 determines the office organization which the user belongs to is equal to the office organization which the target belongs to (YES), the minutes providing unit 202 advances to step S305. In step S305, the minutes providing unit 202 calls the importance level evaluation unit 204. Next, the importance level evaluation unit 204 acquires the weighted coefficient information from the weighted coefficient information storage unit 214. The importance level evaluation unit 204 evaluates a weighted value corresponding to the comment directed at the user's organization, included in the weighted coefficient information is the importance level of the comment.

On the other hand, when the minutes providing unit 202 determines the target is not equal to the user (NO), the minutes providing unit 202 advances to step S306. In step S306, the minutes providing unit 202 calls the importance level evaluation unit 204. The importance level evaluation unit 204 evaluates a weighted value corresponding to the comment directed at the other organization, included in the weighted coefficient information is the importance level of the comment.

In step S307, the minutes providing unit 202 stores, by way of correspondence to each other, the importance level evaluated in step S303 or S305 or S306, comment identification information which identifies comments uniquely and the minutes-of-meeting information in storage apparatus to store the browse information in for example a browse information buffer.

In step S308, the minutes providing unit 202 determines whether there is another comment which has not been evaluated in terms of its importance level in the minutes-of-meeting information with reference to the minutes-of-meeting information storage unit 212. When the minutes providing unit 202 determines there is another comment which has not been evaluated, the minutes providing unit 202 advances to step S302 again.

On the other hand, when the minutes providing unit 202 determines that there is not another comment which has not been evaluated in the importance level, the minutes providing unit 202 advances to step S309. In the step S309, the minutes providing unit 202 generates the browse information by using information stored in the browse information buffer. The minutes providing unit 202 sends the browse information to the information processing apparatus which had requested to browse the minutes of a meeting. The step S309 is end of the process executed by the minutes-of-meeting server.

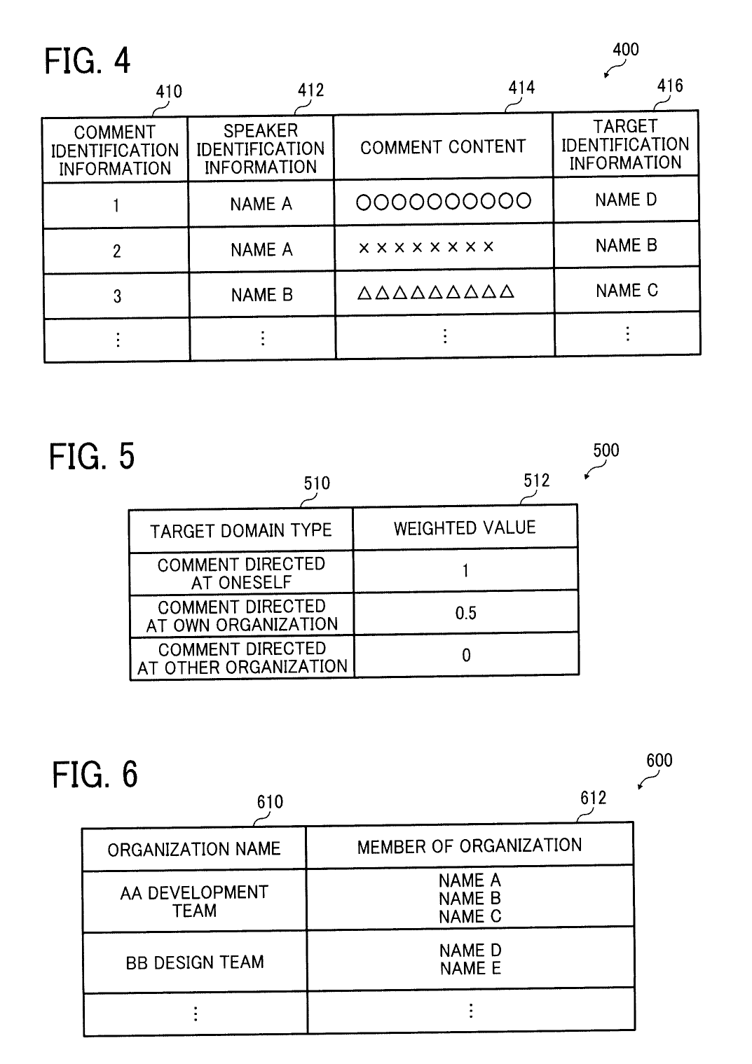

FIG. 4 is a diagram illustrating a minutes-of-meeting information table in which the minutes-of-meeting information is registered in according to this embodiment of the present invention. With reference to FIG. 4, the minutes-of-meeting information table 400 will be described in below.

The minutes-of-meeting information table 400 includes the comment identification information 400, the speaker identification information 412, the comment content 414 and the target identification information 416, these elements stored in correspondence to each other.

The minutes-of-meeting information table 400 includes any or all of the comment identification information corresponding to the comments included in the minutes-of-meeting information registered in the minutes-of-meeting information table 400 as comment identification information 410.

In this embodiment illustrated in FIG. 4, a particular number as the comment identification information 410 is used. But, this invention is not limited to the particular number. Also, an identifier such as a character or a symbol can be used to indentify the comments uniquely.

The minutes-of-meeting information table 400 includes speaker identification information which identifies the speaker of the comment corresponding to the comment identification information by way of speaker identification information 412.

In this embodiment illustrated in FIG. 4, a name of the speaker(“name A”, “name B”) is used as speaker identification information 412. But, the invention is not limited to the name of the speaker. In one embodiment, other identifiers can be used to indentify the speaker uniquely such as a user account, a character, a symbol, a number.

The minutes-of-meeting information table 400 includes comment content corresponding to the comment identification information by way of comment content 414. The comment content is registered with a character string.

The minutes-of-meeting information table 400 includes target identification information which identifies the target (the intended recipient) of the comment corresponding to the comment identification information by way of the target identification information 416.

In this embodiment illustrated in FIG. 4, a name of the target(“name B”, “name C”) is used as target identification information 412. But the invention is not limited to the name of the target. Other target identifications can be used to indentify the target uniquely such as the user account, the character, the symbol, a number.

FIG. 5 is a diagram illustrating a weighted coefficient information table according to this embodiment of the present invention. With reference to FIG. 5, the weighted coefficient information 500 will be described in below.

The weighted coefficient information 500 includes a target domain type 510 and a weighted value 512. The target domain type 510 and the weighted value 512 are registered in the weighted coefficient information storage unit 214, in a way of corresponding to each other.

The type of comment 510 is a type of a comment included in the minutes-of-meeting information. In the embodiment illustrated in FIG. 5, there are “a comment directed at oneself,” “a comment directed at own organization,” and “a comment directed at other organization.” The comment directed at oneself indicates the comment is directed at the user. The comment directed at own organization indicates the comment is directed at the organization to which the user belongs to. The comment directed at other organization indicates the comment is directed at the organization to which the user does not belong to.

In one embodiment, the weighted value is used for evaluating the importance level of the comment. The weighted value is appropriated a value corresponding to a target domain type. The weighted value for evaluating the importance level for the target of comment is appropriated as the weighted value of the target domain type “the comment directed at oneself.” The weighted value for evaluating the importance level for a member of organization for which the target of comment belongs to is appropriated as the weighted value of the target domain type “the comment directed at own organization.” The weighted value for evaluating the importance level for a member of organization which the target of comment does not belong to is appropriated as the weighted value of the target domain type “the comment directed at own organization.”

In this embodiment, the target domain type “the comment directed at oneself” is appropriated “1” as the weighted value. The target domain type “the comment directed at own organization” is appropriated “0.5” as the weighted value. The target domain type “the comment directed at other organization” is appropriated “0” as the weighted value.

In this embodiment, the target domain type “comment directed at oneself” is treated as most important comment. The target domain type “comment directed at own organization” is treated as the second most important comment. But the present invention is not limited to these weighted values but can include others which reflect the same order.

FIG. 6 is a diagram illustrating an office organization information table where the office organization information is registered, according to one aspect of this embodiment of the present invention. With reference to FIG. 6, the office organization information 600 is described in blow.

The office organization information table 600 includes an organization name 610 and a member of organization 612, included in correspondence to each other.

The office organization information table 600 registers a name of the organization which the speaker belongs to, or a name of the organization which the target belongs to, or a name of the organization which the user of the information processing system 100 belongs to as the organization name 610. In the embodiment illustrated in FIG. 6, the name of organization is denoted as organization name. But the invention is not limited to the name of organization. Also, another organization identifier can be used to indentify the organization uniquely such as the organization account, the character, the symbol, a number.

The office organization information table 600 registers identification information identifying a member who belongs to the organization corresponding to the organization name (describe “organization member identification information” in below) as member of organization 612. In this embodiment, the name of member who belongs to the organization (“name A”, “name B”) is used as organization member identification information. But the invention is not limited to the name of the member. Also, another organization member identifier can be used to indentify the member uniquely such as the user account, the character, the symbol, a number.

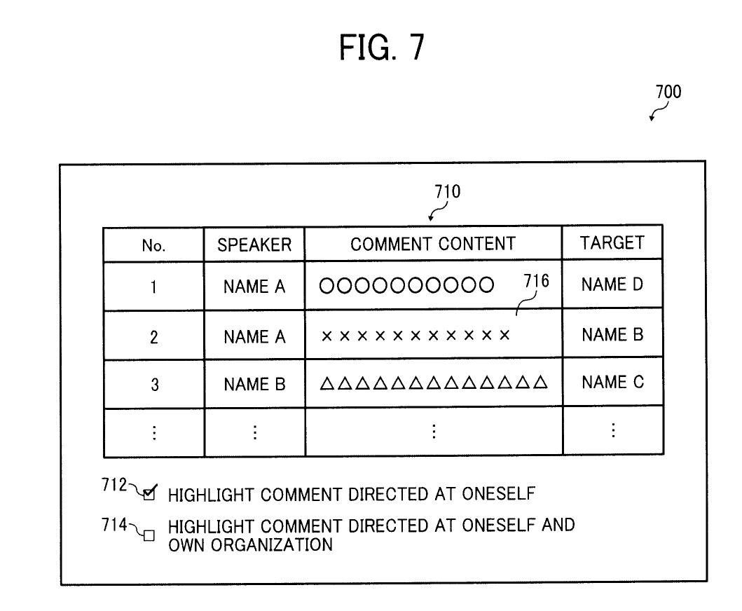

FIG. 7 is a diagram illustrating a browse-information displaying screen which is displayed on a display unit of the information processing apparatus, according to an aspect of this embodiment of the present invention. With reference to FIG. 7, the browse-information displaying screen 700 is described in below. The minutes-of-meeting information 710 provided by the minutes-of-meeting server 114 is displayed in the browse-information displaying screen 700. Further, check boxes 712, 714 are displayed in the browse-information displaying screen 700. The check boxes 712, 714 are used for directing to highlight comment content 414.

In this embodiment illustrated in FIG. 7, the comment identification information, the speaker identification information, the comment content, and the target identification information are displayed in the browse-information displaying screen 700, as the minutes-of-meeting information 710. In this embodiment, it is preferred, but not required, that the name of the speaker and the name of the target as the speaker identification information and as the target identification information are displayed in the browse information displaying screen 700. The check boxes 712, 714 are graphical user interface (GUI) objects used for directing to highlight comment content 414.

The check boxes 712 are the GUI objects for directing highlighted comments associated with the user who sent the browse request of the minutes-of-meeting information. The check boxes 714 are the GUI objects for directing highlighted comments associated with the user who sent the browse request and for directing to comments associated with the organization to which the user belongs to.

When the user designates the check boxes 712, 714 on the browse information displaying screen 700 with an input device such as a mouse of the information processing apparatus, the information processing apparatus 112a, 112b, 112c sends, to the minutes-of-meeting server 114, a notification denoting that the GUI object is designated. When the minutes-of-meeting server 114 receives the notification, the minutes providing unit 202 of the minutes-of-meeting server 114 determines which check box is designated.

In the case in which, the check box 712 is designated, the minutes providing unit 202 acquires the browse information which was sent to the information processing apparatus from the browse information buffer. The minutes providing unit 202 generates the browse information which includes for example the highlighted comment content evaluated for when the importance level is greater or equal to the “1” value. The minutes providing unit 202 sends the browse information to the information processing apparatus 112a, 112b, 112c.

In the case in which, the check box 714 is designated, the minutes providing unit 202 acquires the browse information which was sent to the information processing apparatus from the browse information buffer. The minutes providing unit 202 generates the browse information which includes highlighted comment content evaluated for when the importance level is greater or equal to the “0.5” value. The minutes providing unit 202 sends the browse information to the information processing apparatus 112a, 112b, 112c. In this aspect of this embodiment, the comment content 414 to be highlighted is selected based on the weighted value included in the weighted coefficient information stored in the weighted coefficient information storage unit 214.

When the information processing apparatus 112a, 112b, 112c receives the browse information, the information processing apparatus displays highlighted comment content in the browse-information displaying screen 700 on the display unit. In the embodiment illustrated in FIG. 7, the check box 712 is designated. The comment content 716 (directed at the user who submitted the browse request) is indicated by boldface. In another aspect of this embodiment, another feature besides a boldface can be used. Further, in another aspect of this embodiment, other GUI objects can be used such as for example a radio box, a toggle button, a combo box, and a list on behalf of the check box. Further, in another aspect of this embodiment, the information processing apparatus generates the browse information displaying screen including only the comment contents directed at the user who submitted the browse request.

### Second Embodiment

The second embodiment of the present invention will now be described with reference to the above-described first embodiment. Descriptions of the configurations having the reference numerals same as those in the first embodiment are omitted unless there is a special necessity.

In the second embodiment, there can be a plurality of targets (e.g., intended recipients) corresponding to one comment identification information. The minutes-of-meeting information table in the second embodiment is different from the minutes-of-meeting information table 400 in the first embodiment in respect to the number of targets included in the table.

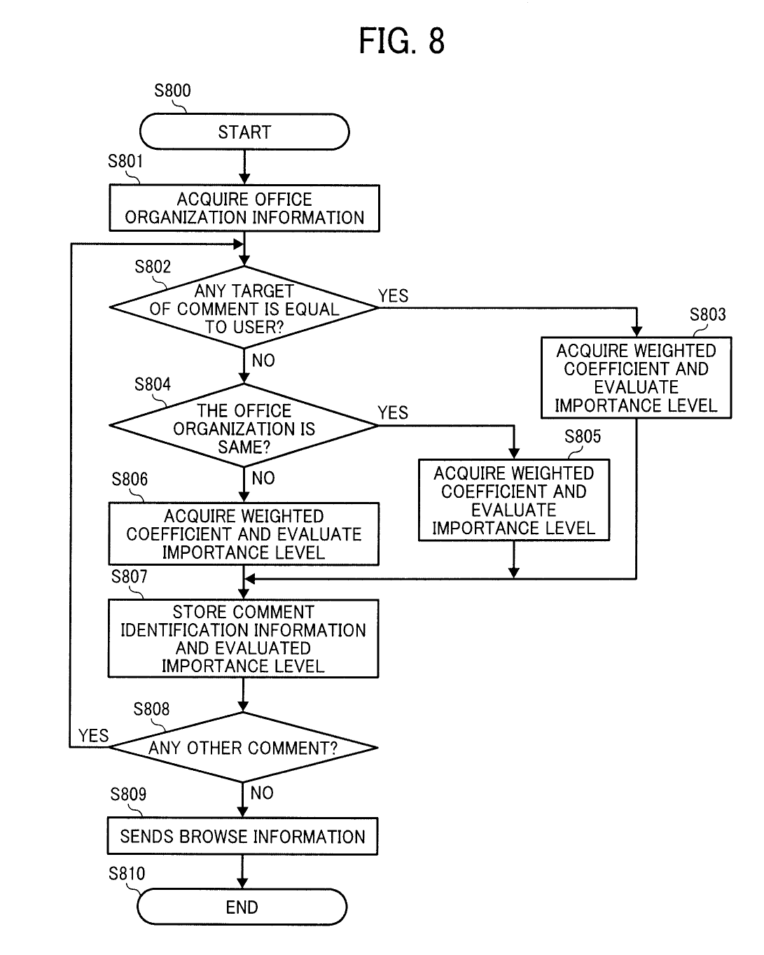

FIG. 8 is a flowchart illustrating the process executed by the minutes-of-meeting server according to second embodiment of the present invention. With reference to FIG. 8, the process executed by the minutes-of-meeting server 114, in the case in which there are a plurality of targets for one or more of the comments included in the minutes-of-meeting information, will be described in below.

The process illustrated in FIG. 8 starts with that the communication unit 210 in the minutes-of-meeting server 114 receiving the browse request of the minutes-of-meeting information from the information processing apparatus 112a, 112b, 112c in step S800, as is the case with the process illustrated in FIG. 3.

In step S801, the minutes providing unit 202 receives the browse request from the communication unit 210 and providing unit 202 calls the importance level evaluation unit 204. Further, in step S801, the importance level evaluation unit 204 calls the office organization information acquiring unit 206 and makes the office organization information acquiring unit 206 to acquire the office organization information from the office organization information server 116.

In step 802, the minutes providing unit 202 determines whether any one of the target identification information identifying targets of the comment included in the minutes-of-meeting information is equal to the user identification information included in the browse request, with reference to the minutes-of-meeting information storage unit 212.

The minutes providing unit 202 determines whether any one of the targets is equal to the user.

When the minutes providing unit 202 determines that any one of the targets is equal to the user (YES), the minutes providing unit 202 advances to step S803. In the step S803, the minutes providing unit 202 calls the importance level evaluation unit 204. Next, the importance level evaluation unit 204 acquires the weighted coefficient information from the weighted coefficient information storage unit 214. The importance level evaluation unit 204 evaluates a weighted value, included in the weighted coefficient information and corresponding to the comment directed at the user, according to the importance level of the comment.

On the other hand, when the minutes providing unit 202 determines any one of the targets is not equal to the user (NO), the minutes providing unit 202 advances to step S804.

In step S804, the minutes providing unit 202 acquires an office organization of the user with reference to the office organization information acquired in step S301, based on the user identification information, the minutes providing unit 202 acquires an office organization of each of the targets with reference to the office organization information acquired in step S301, based on any or all of the targets' identification information. The minutes providing unit 202 determines whether the office organization which the user belongs to is equal to any one of the office organizations the targets belong to.

When the minutes providing unit 202 determines that the office organization the user belongs to is equal to any one of the office organization the targets belong to (YES), the minutes providing unit 202 advances to step S805. In step S805, the minutes providing unit 202 calls the importance level evaluation unit 204. Next, the importance level evaluation unit 204 acquires the weighted coefficient information from the weighted coefficient information storage unit 214. The importance level evaluation unit 204 evaluates the weighted value corresponding to the comment directed at the target organization. Included in the weighted coefficient information is the importance level of the comment.

On the other hand, when the minutes providing unit 202 determines any one of the target is not equal to the user (NO), the minutes providing unit 202 advances to step S806. In step S806, the minutes providing unit 202 calls the importance level evaluation unit 204. The importance level evaluation unit 204 evaluates the weighted value corresponding to the comment directed at other organization and included in the weighted coefficient information, the importance level of the comment.

In step S807, the minutes providing unit 202 stores, in correspondence to each other, the importance level evaluated in step S803 or S805 or S806, the comment identification information which identifies comments uniquely, and the minutes-of-meeting information in the browse information buffer in below.

In step S808, the minutes providing unit 202 determines whether there is another comment which has not been evaluated and the importance level of the other comment in the minutes-of-meeting information with reference to the minutes-of-meeting information storage unit 212. When the minutes providing unit 202 determines there is another comment which has not been evaluated and the importance level of the other comment in the minutes-of-meeting information, the minutes providing unit 202 advances to step S802 again.

On the other hand, when the minutes providing unit 202 determines there is not another comment which has not been evaluated, the minutes providing unit 202 advances to step S809. In the step S809, the minutes providing unit 202 generates the browse information, using information stored in the browse information buffer. The minutes providing unit 202 sends the browse information to the information processing apparatus which requested browsing of the minutes of meeting. Step S809 is end of the process executed by the minutes-of-meeting server.

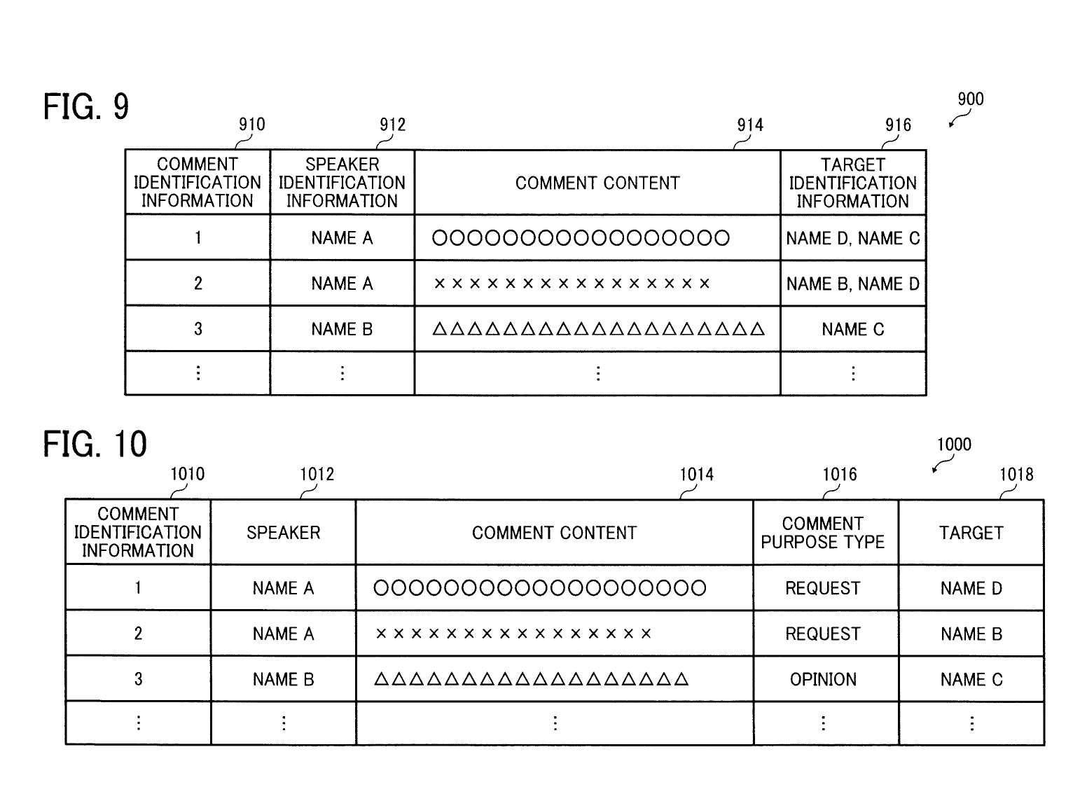

FIG. 9 is a diagram illustrating the minutes-of-meeting information table in which the minutes-of-meeting information is registered in according to second embodiment of the present invention. The minutes-of-meeting information table 900 illustrated in FIG. 9 is almost the same as the minutes-of-meeting information table 400 illustrated in FIG. 4.

The minutes-of-meeting information table 900 in the second embodiment includes a plurality of target identification information (for example, “name D”,“name C”) corresponding to one comment identification information (for example, “1”).

### Third Embodiment

The third embodiment of the present invention will now be described with reference to the above-described first embodiment. Descriptions of the configurations having the reference numerals same as those in the first embodiment are omitted unless there is a special necessity. In the third embodiment, there are comment purpose type indicia corresponding to the comment identification information in the minutes-of-meeting information table.

FIG. 10 is a diagram illustrating the minutes-of-meeting information table in which the minutes-of-meeting information is registered in according to third embodiment of the present invention. The minutes-of-meeting information table 1000 illustrated in FIG. 10 includes the comment purpose type indicia corresponding to the comment identification information. Additionally, in comparison with the minutes-of-meeting information table 400 illustrated in FIG. 4, with reference to FIG. 10, the minutes-of-meeting information table 1000 will be described below. The comment purpose type indicia are registered in the comment purpose type 1016. The comment purpose type denotes an intent or a purpose of the comment content. In FIG. 10, comment purpose type indicia that can be used as the comment purpose type include a “request” which denotes a request to the target of the comment and an “opinion” which denotes an opinion to the target of the comment. Further, comment purpose type indicia which can be used as the comment purpose type include “publicity” which denotes intelligence sharing to the target of comments or to another person.

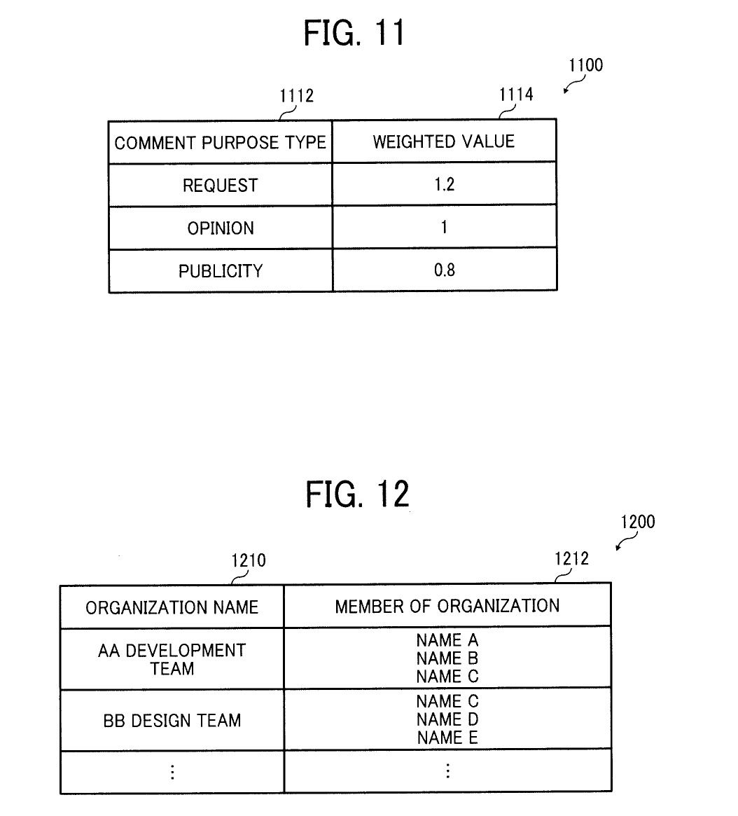

FIG. 11 is a diagram illustrating the weighted coefficient information table according to third embodiment of the present invention. With reference to FIG. 11, the weighted coefficient information 1100 will be described in below.

The weighted coefficient information 1100 includes in the comment purpose type 1112 and the weighted value 1114 in correspondence to each other.

The comment purpose type indicia is included in the minutes-of-meeting information. Comment purpose type indicia which can be used as the comment purpose type include a “request” which denotes a request to the target of the comment, and an “opinion” which denotes an opinion to the target of the comment, and “publicity” which denotes intelligence sharing to the target of comments or to another person.

The weighted value 1114 is used for evaluating the importance level of comment. The weighted value is appropriated to each value in correspondence to the comment purpose type 1112. In one aspect of this embodiment, the comment purpose type “request” is appropriated “1.2” as the weighted value, the comment purpose type “opinion” is appropriated “1” as the weighted value, and the comment purpose type “publicity” is appropriated “0.8” as the weighted value.

In one aspect of this embodiment, the comment purpose type “request” is treated as the most important comment. The comment purpose type “opinion” is treated as second most important comment. The present invention is not limited to these weighted value. Any value can be used as the weighted value. In this embodiment, the minutes providing unit 202 in the minutes-of-meeting server 114 acquires the minutes-of-meeting information.

The minutes providing unit 202 acquires the comment purpose type indicia and the target of comment with reference to the minutes-of-meeting information. Next, the minutes providing unit 202 calls the importance level evaluation unit 204. The importance level evaluation unit 204 acquires the weighted coefficient information illustrated in FIG. 5, and the weighted coefficient information illustrated in FIG. 11 from the weighted coefficient information storage unit 214.

The importance level evaluation unit 204 evaluates the importance level of the comment based on the weighted values included in the weighted coefficient information.

More specifically, the importance level evaluation unit 204 acquires the first weighted value corresponding to the target of comment based on weighted coefficient information illustrated in FIG. 5. The importance level evaluation unit 204 acquires the second weighted value corresponding to the comment purpose type indicia based on weighted coefficient information, illustrated in FIG. 11. The importance level evaluation unit 204 evaluates the importance level by multiplication or addition of the first weighted value and the second weighted value.

Thus, the minutes-of-meeting server 114 evaluates the importance level of comment included in the minutes-of-meeting information, through the use of the intent or the purpose of the comment content.

### Fourth Embodiment

The fourth embodiment of the present invention will now be described with reference to the above-described first embodiment. Descriptions of the configurations having the reference numerals same as those in the first embodiment are omitted unless there is a special necessity. In the fourth embodiment, one person belongs to a plurality of the office organizations.

FIG. 12 is a diagram illustrating the office organization information table which the office organization information is registered in according to fourth embodiment of the present invention. The office organization information table 1200 illustrated in FIG. 12, is different from the office organization information table 600 illustrated in FIG. 6, in respect that there is the organization member identification information (for example, “name C”) which is registered corresponding to a plurality of the office organizations (for example, “AA development Team”, “BB design Team”).

In the fourth embodiment, the office organization information acquiring unit 206 in the minutes-of-meeting server 114 acquires the office organization information illustrated in FIG. 12.

Further, the minutes providing unit 202 acquires an office organization of the user with reference to the office organization information acquired, based on the user identification information. The minutes providing unit 202 acquires an office organization of the target with reference to the office organization information acquired, based on the target identification information.

The minutes providing unit 202 determines whether the office organization, which the user belongs to, is equal to the office organization of the target. Based on this determination, the minutes providing unit 202 calls the importance level evaluation unit 204. The importance level evaluation unit 204 evaluates a weighted value corresponding to the target domain, as the importance level of the comment.

Thus, the minutes-of-meeting server 114 evaluates the importance level of comment included in the minutes-of-meeting information, even where one person belongs to a plurality of office organizations.

### Fifth Embodiment

The fifth embodiment of the present invention will now be described with reference to the above-described first embodiment. Descriptions of the configurations having the reference numerals same as those in the first embodiment are omitted unless there is a special necessity. In the fifth embodiment, there is a hierarchical structure of the office organization.

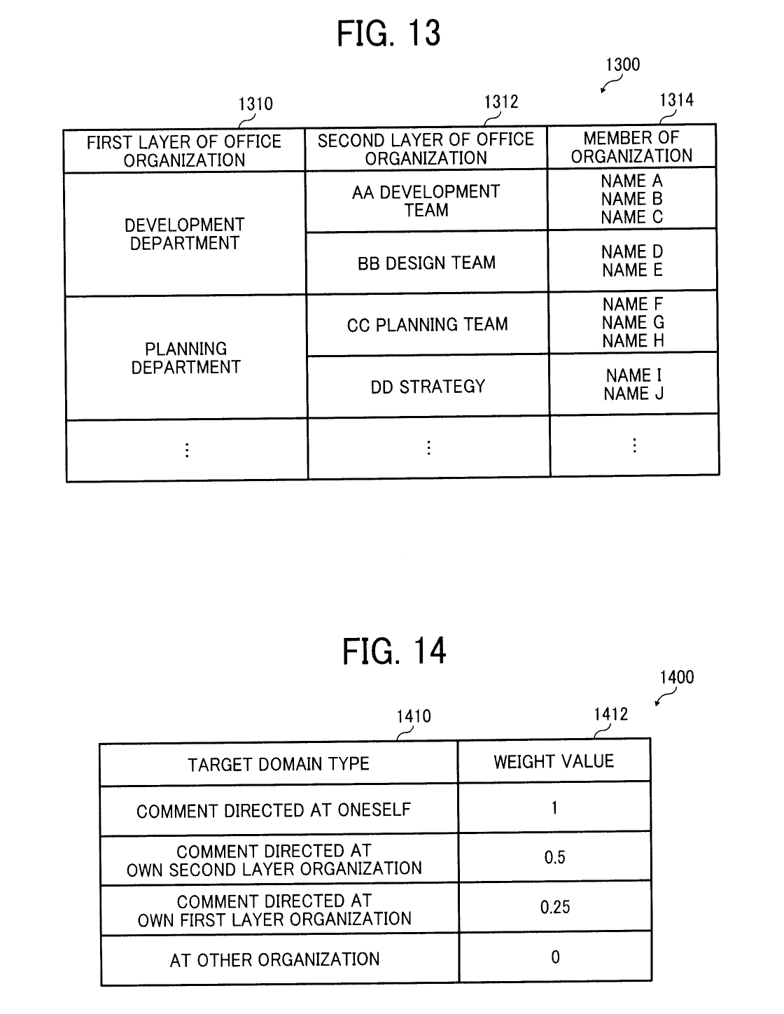

FIG. 13 is a diagram illustrating the office organization information table 1300 in which the office organization information is registered according to fifth embodiment of the present invention. The office organization information table 1300 illustrated in FIG. 13, is different from the office organization information table 600 illustrated in FIG. 6, in respect that there are a first layer organization and a second layer organization. With reference to FIG. 13, the office organization information table 1300 will be described below. The office organization information table 1300 includes the first layer organization 1310, the second layer organization 1312, and the member of organization 1314 in correspondence to each other.

The office organization information table 1300 registers a name of a first layer of the office organization which the speaker belongs to, or a name of a first layer of the office organization which the target belongs to, or a name of a first layer of office organization which the user of the information processing system 100 belongs to as the first layer organization 1310.

The office organization information table 1300 registers a name of second layer of the office organization which the speaker belongs to, or a name of a second layer of the office organization which the target belongs to, or a name of a second layer of office organization which the user of the information processing system 100 belongs to as the second layer organization 1312. The first layer of office organization is higher than the second layer of office organization in the hierarchical structure of the office organization. In this aspect of this embodiment illustrated in FIG. 13, the name of the first layer of office organization and the name of the second layer of office organization are denoted as the first layer organization 1310 and the second layer organization 1312. The present invention is not limited to the name of these organizations. Also, other identities can be used to indentify these organizations uniquely such as an organization account, a character, a symbol, a number.

The office organization information table 1300 registers the identification information identifying member who belongs to the second layer of office organization corresponding to the name of second layer of office organization (describe “the organization member identification information” below) as member of organization 1314. In this embodiment, the name of member (“name A”, “name B”, “name C”) who belongs to the second layer of organization (for example, “AA developing Team”) is used as organization member identification information. The present invention is not limited to the name of the member. Also, other names can be used to indentify the member uniquely such as a user account, a character, a symbol, a number.

FIG. 14 is a diagram illustrating the weighted coefficient information table according to the fifth embodiment of the present invention. With reference to FIG. 14, the weighted coefficient information table 1400 will be described in below.

The weighted coefficient information 1400 includes a target domain type 1410 and weighted value 1412. Target domain type and weighted values are registered in the weighted coefficient information storage unit 214, in correspondence to each other.

The target domain type 1410 is a type of a comment included in the minutes-of-meeting information. In the embodiment illustrated in FIG. 14, there are “a comment directed at oneself,” “a comment directed at own second layer organization,” “a comment directed at own first layer organization” and “comment directed at other organization.” The comment directed at oneself indicates the comment is directed at the user. The comment directed at own second layer organization indicates the comment is directed at the second layer of organization that the user belongs to. The comment directed at own first layer organization indicates the comment is directed at the first layer of organization that the user belongs to, but is not directed at the second layer of organization that the user belongs to. The comment directed at other organization indicates the comment is directed at an organization that the user dose not belong to.

The weighted value 1412 is used for evaluating the importance level of the comment. The weighted value is appropriated each value correspond to the target domain type 1410.

The weighted value for evaluating the importance level for the target of comment is appropriated as the weighted value of the target domain type “the comment directed at oneself.” The weighted value for evaluating the importance level for a member of second layer of organization which the target of comment belongs to is appropriated as the weighted value of the target domain type “the comment directed at own second layer of organization.” The weighted value for evaluating the importance level for a member, who belongs to the first layer of organization which the target of comment belongs to and who does not belongs to the second layer of organization which the target of comment belongs to, is appropriated as the weighted value of the target domain type “the comment directed at own first layer of organization.” The weighted value for evaluating the importance level for a member of organization which the target of comment does not belong to is appropriated as the weighted value of the target domain type “the comment directed at own organization.”

In one aspect of this embodiment, the target domain type “the comment directed at oneself” is appropriated “1” as the weighted value. The target domain type “the comment directed at own second layer of organization” is appropriated “0.5” as the weighted value. The target domain type “the comment directed at own first layer of organization” is appropriated “0.25” as the weighted value. The target domain type “the comment directed at other organization” is appropriated “0” as the weighted value. In one aspect of this embodiment, the target domain type “comment directed at oneself” is treated as the most important comment. The target domain type “comment directed at own second layer of organization” is treated as the second most important comment. The target domain type “comment directed at own first layer of organization” is treated as the third most important comment. The present invention is not limited to these weighted values and can include other values the encompassing the same order.

In the fifth embodiment, the office organization information acquiring unit 206 in the minutes-of-meeting server 114 acquires the office organization information, as illustrated in FIG. 13.

Further, the minutes providing unit 202 acquires the first layer of office organization of the user and the second layer of office organization of the user with reference to the office organization information acquired, based on the user identification information. The minutes providing unit 202 acquires the first layer of office organization of the target and the second layer of office organization of the target with reference to the office organization information acquired, based on the target identification information.

In the step S304 illustrated in FIG. 3, the minutes providing unit 202 determines whether the second layer of office organization the user belongs to is equal to the second layer of an office organization of the target and whether the first layer of the office organization the user belongs to is equal to the first layer of the office organization of the target.

Based on this determination, the minutes providing unit 202 calls the importance level evaluation unit 204. The importance level evaluation unit 204 evaluates the weighted value corresponding to the type of comment with reference to comment from weighted coefficient information illustrated in FIG. 14 as the importance level of the comment.

Thus, it is performed that the minutes-of-meeting server 114 evaluates the importance level of comment included in the minutes-of-meeting information, even where there is an hierarchical structure of the office organization.

### Sixth Embodiment

The sixth embodiment of the present invention will now be described with reference to the above-described first embodiment. Descriptions of the configurations having the reference numerals same as those in the first embodiment are omitted unless there is a special necessity. In the sixth embodiment, there is information about an appointment in the office organization information table 1500.

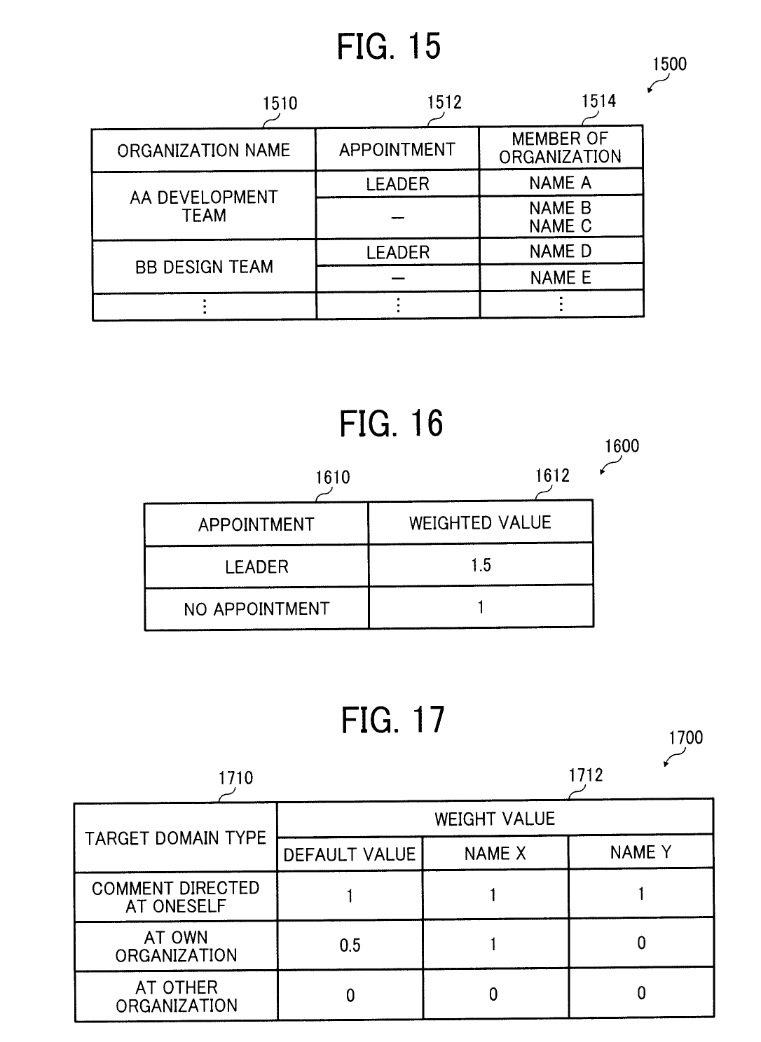

FIG. 15 is a diagram illustrating the office organization information table 1500 in which the office organization information is registered according to sixth embodiment of the present invention.

The office organization information table 1500 illustrated in FIG. 15, is different from the office organization information table 600 illustrated in FIG. 6, in respect that there is information about the appointment in the office organization information table 1500. With reference to FIG. 15, the office organization information table 1500 including information about an appointment will be described below. The office organization information table 1500 includes organization name 1510, appointment 1512, and member of organization 1514.

The office organization information table 1500 registers the name of the office organization which the speaker belongs to, which the target belongs to, or which the user of the information processing system 100 belongs to as the organization name 1510.

In FIG. 15, it is a name of the office organization which is used as the organization name 1510. The present invention is not limited to the name of the office organization. Also, any organizational name can be used to indentify the office organization uniquely such as a character, a symbol, a number.

The office organization information table 1500 registers the organization member identification information for each member of organization 1514.

The office organization information table 1500 registers the appointment of the member indicated by the organization member identification information appointment 1512.

As illustrated in FIG. 15, the appointment “leader” is registered corresponding to the member (“name A”, “name B”). The present invention is not limited to the “leader”. A variety of appointment can be registered. As illustrated in FIG. 15, a name of the member is used as the organization member identification information. The present invention is not limited to the name of the member. Other items can be used to indentify the member uniquely such as a account, a character, a symbol, a number.

FIG. 16 is a diagram illustrating the weighted coefficient information table according to the sixth embodiment of the present invention. With reference to FIG. 16, the weighted coefficient information will be described below.

The weighted coefficient information 1600 includes the appointment 1610 and the weighted value 1612. The appointment 1610 and the weighted value 1612 are registered in the weighted coefficient information storage unit 214, in correspondence to each other. The weighted value 1612 is registered corresponding to the appointment 1610, which can be an appointment of the speaker of comment included in the minutes-of-meeting information in weighted coefficient information 1600.

In one aspect of this embodiment, the appointment “leader” is appropriated “1.5” as the weighted value. The appointment “no appointment” is appropriated “1.0” as the weighted value. In this embodiment, the comment of the leader is treated as the most important comment. The present invention is not limited to these weighted values can encompass values of the same order. In one aspect of this embodiment, the minutes providing unit 202 in the minutes-of-meeting server 114 acquires the minutes-of-meeting information. The minutes providing unit 202 acquires the speaker identification information 412 and the target identification information 416 with reference to the minutes-of-meeting information. Further, the office organization information acquiring unit 206 in the minutes-of-meeting server 114 acquires the office organization information illustrated in FIG. 15.

The minutes providing unit 202 acquires the office organization of the user, with reference to the office organization information acquired, based on the user identification information. The minutes providing unit 202 acquires the office organization of the target, with reference to the office organization information acquired, based on the target identification information. Further, the minutes providing unit 202 acquires the appointment of the speaker, with reference to the office organization information based on the speaker identification information 412.

In the step S304 illustrated in FIG. 3, the minutes providing unit 202 determines whether the user is equal to the target, determines whether the office organization the user belongs to is equal to the office organization of the target. The minutes providing unit 202 determines the target domain type. Next, the minutes providing unit 202 calls the importance level evaluation unit 204. The importance level evaluation unit 204 acquires the weighted coefficient information illustrated in FIG. 5 and the weighted coefficient information illustrated in FIG. 16 from the weighted coefficient information storage unit 214. The importance level evaluation unit 204 evaluates the importance level of the comment based on the weighted values included in the weighted coefficient information.

More specifically, the importance level evaluation unit 204 acquires the first weighted value corresponding to the target domain type based on weighted coefficient information illustrated in FIG. 5. The importance level evaluation unit 204 acquires the second weighted value corresponding to the appointment based on weighted coefficient information illustrated in FIG. 16. The importance level evaluation unit 204 evaluates the importance level by multiplication or addition the first weighted values and the second weighted value. Thus, the minutes-of-meeting server 114 evaluates the importance level of comment included in the minutes-of-meeting information, through the use of the appointment of the speaker of the comment.

### Seventh Embodiment

The seventh embodiment of the present invention will now be described with reference to the above-described first embodiment. Descriptions of the configurations having the reference numerals same as those in the first embodiment are omitted unless there is a special necessity. In the seventh embodiment, there are various weighted values according to the user in the weighted coefficient information.

FIG. 17 is a diagram illustrating the weighted coefficient information table according to seventh embodiment of the present invention;

The weighted coefficient information illustrated in FIG. 17, is different from the weighted coefficient information illustrated in FIG. 5, in respect that there are various weighted values according to the user in the weighted coefficient information.

With reference to FIG. 17, the weighted coefficient information will be described below.

The weighted coefficient information 1700 includes a target domain type 1710 and weighted value 1712. The target domain type 1710 and the weighted value 1712 are registered in the weighted coefficient information storage unit 214, in correspondence to each other.

The target domain type 1710 is the same as the target domain type 1410.

The weighted value 1712 is used for evaluating the importance level of the comment. The weighted value is appropriated each value correspond to a combination of the target domain type 1410 and the user. There is a default value for a user who is not registered a weighted value.

In one aspect of this embodiment, the combination of the target domain type “the comment directed at oneself” and the default value is appropriated “1” as the weighted value. The combination of the target domain type “the comment directed at own organization” and the default value is appropriated “0.5” as the weighted value. The combination of the target domain type “the comment directed at other organization” and the default value is appropriated “0” as the weighted value.

The combination of the target domain type “the comment directed at oneself” and the “user X” is appropriated “1” as the weighted value. The combination of the target domain type “the comment directed at own organization” and the “user X” is appropriated “1” as the weighted value. The combination of the target domain type “the comment directed at other organization” and the “user X” is appropriated “0” as the weighted value.

The combination of the target domain type “the comment directed at oneself” and the “user Y” is appropriated “1” as the weighted value. The combination of the target domain type “the comment directed at own organization” and the “user Y” is appropriated “0” as the weighted value. The combination of the target domain type “the comment directed at other organization” and the “user Y” is appropriated “0” as the weighted value.

In one aspect of this embodiment, the described above weighted value is used. The present invention is not limited to these weighted values but can include other values encompassing the same order.

In one aspect of this embodiment, the minutes providing unit 202 in the minutes-of-meeting server 114 acquires the minutes-of-meeting information. The minutes providing unit 202 acquires the target identification information 416 with reference to the minutes-of-meeting information. Further, the office organization information acquiring unit 206 in the minutes-of-meeting server 114 acquires the office organization information, as illustrated in FIG. 6.

The minutes providing unit 202 acquires the office organization of the user, with reference to the office organization information acquired, based on the user identification information. The minutes providing unit 202 acquires the office organization of the target, with reference to the office organization information acquired, based on the target identification information.

In the step S304 illustrated in FIG. 3, the minutes providing unit 202 determines whether the user is equal to the target, determines whether the office organization which the user belongs to is equal to the office organization of the target. The minutes providing unit 202 determines the target domain type. Next, the minutes providing unit 202 calls the importance level evaluation unit 204. The importance level evaluation unit 204 acquires the weighted coefficient information illustrated in FIG. 17 from the weighted coefficient information storage unit 214. The importance level evaluation unit 204 evaluates the importance level of the comment, based on the combination of target domain type and the user, with reference to the weighted values included in the weighted coefficient information illustrated in FIG. 17. Thus, the minutes-of-meeting server 114 evaluates the importance level of comment corresponding to the user.

### Eighth Embodiment

The eighth embodiment of the present invention will now be described with reference to the above-described first embodiment. Descriptions of the configurations having the reference numerals same as those in the first embodiment are omitted unless there is a special necessity. In the eighth embodiment, the information processing system 1800 does not include the office organization information server 116. The minutes-of-meeting server 1814 does not include the office organization information acquiring unit 206. Alternatively, in this embodiment, the minutes-of-meeting information includes the organization name.

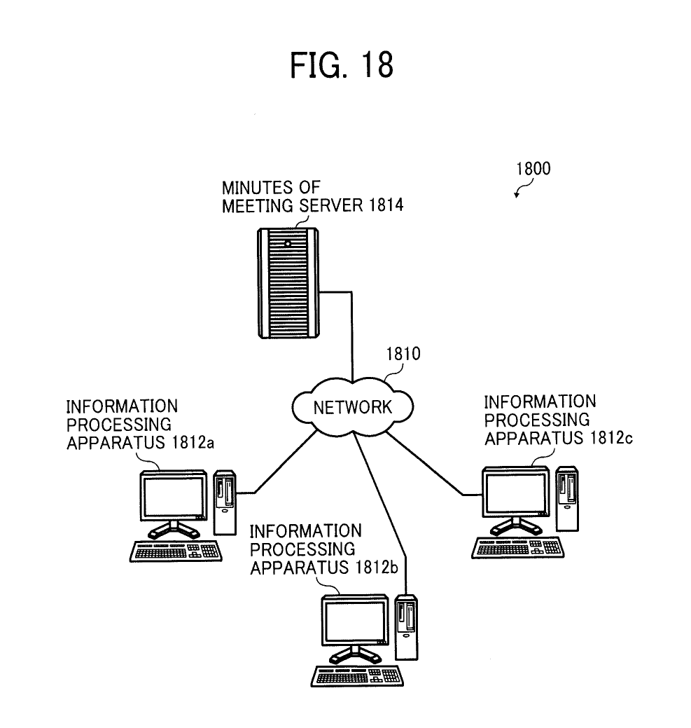

FIG. 18 is a diagram illustrating the information processing system according to the eighth embodiment of the present invention.

The information processing system 1800 includes the information processing apparatuses 1812a,1812b,1812c connected to the network 1810, the minutes-of-meeting server 1814.

The information processing system 1800 illustrated in FIG. 18 is different from the information processing system 100 illustrated in FIG. 1 in respect that the information processing system 1800 does not include the office organization information server 116.

However, the network 1810 and the information processing apparatus 1812a, 1812b, 1812c included in the information processing system 1800 are the same as the network 110 and the information processing apparatuses 112a, 112b, 112c included in the information processing system 100 substantively.

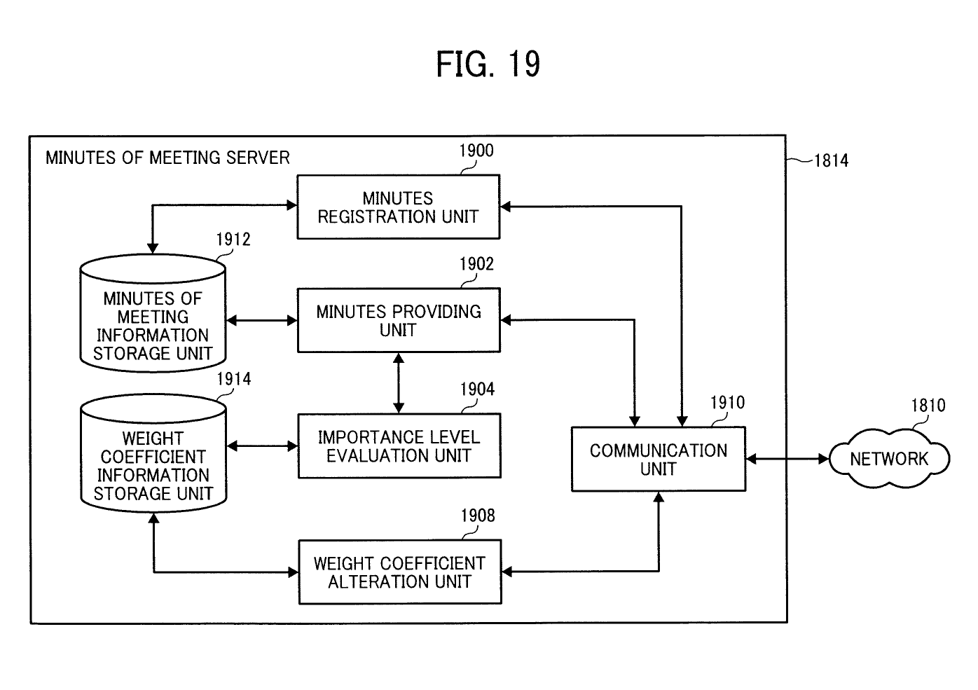

FIG. 19 is a block diagram of the minutes-of-meeting server 1814 according to eighth embodiment of the present invention.

The minutes-of-meeting server 1814 includes a minutes registration unit 1900, a minutes providing unit 1902, an importance level evaluation unit 1904, a weighted coefficient alteration unit 1908, a communication unit 1910, the minutes-of-meeting information storage unit 1912, a weighted coefficient information storage unit 1914. The minutes-of-meeting server 1814 illustrated in FIG. 19 is different from the information processing system 114 illustrated in FIG. 2 in respect that minutes-of-meeting server 1814 does not include the office organization information acquiring unit 206. However, the minutes registration unit 1900, the minutes providing unit 1902, the importance level evaluation unit 1904, the weighted coefficient alteration unit 1908, the communication unit 1910, the minutes-of-meeting information storage unit 1912 and the weighted coefficient information storage unit 1914 are the same as the minutes registration unit 200, the minutes providing unit 202, the importance level evaluation unit 204, the weighted coefficient alteration unit 208, the communication unit 210, the minutes-of-meeting information storage unit 212 and the weighted coefficient information storage unit 214 substantively.

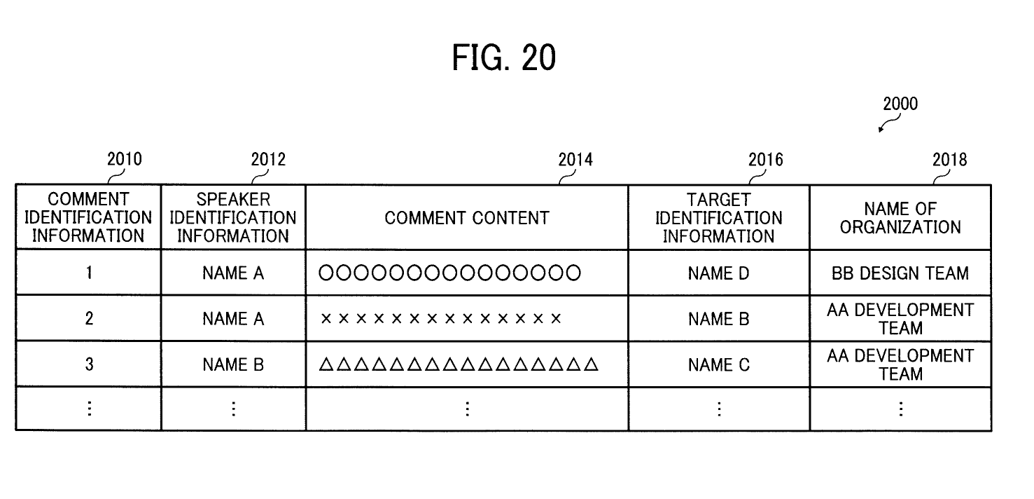

FIG. 20 is a diagram illustrating the minutes-of-meeting information table 2000 in which minutes-of-meeting information is registered in according to the eighth embodiment of the present invention. With reference to FIG. 20, the minutes-of-meeting information table 2000 will be described below.

The minutes-of-meeting information table 2000 includes the comment identification information 2010, the speaker identification information 2012, the comment content 2014, the target identification information 2016 and the organization name 2018 in correspondence to each other.

The minutes-of-meeting information table 2000 illustrated in FIG. 20 is different from the minutes-of-meeting information table 400 illustrated in FIG. 4 in respect that the minutes-of-meeting information table 2000 includes the organization name 2018. However, the comment identification information 2010, the speaker identification information 2012, the comment content 2014 and the target identification information 2016 are the same as the comment identification information 410, the speaker identification information 412, the comment content 414 and the target identification information 416 substantively.

The minutes-of-meeting information table 2000 includes any or all names of the office organization that the target belongs to corresponding to each comment as the organization name 2018.

In this embodiment illustrated in FIG. 20, the organization name “BB design Team” is registered in the way of corresponding to the target identification information “name D.” The present invention is not limited to the name of the office organization. Also, other identities can be used to indentify the office organization uniquely such as a character, a symbol, a number.

In one aspect of this embodiment, the communication unit 1910 in the minutes-of-meeting server 1814 receives the browse request of the minutes-of-meeting information and the organization name the user who submits the browse request belongs to, from the information processing apparatus 112a, 112b, 112c in step S300. In step S301, the minutes providing unit 1902 receives the browse request and the organization name which the user belongs to from the communication unit 1910, and providing unit 1902 calls the importance level evaluation unit 1904.

In step 302, the minutes providing unit 1902 determines whether a target identification information identifying a target of the comment included in the minutes-of-meeting information is equal to the user identification information included in the browse request, with reference to the minutes-of-meeting information storage unit 1912. The minutes providing unit 1902 determines whether the target is equal to the user.

In the step S304, the minutes providing unit 1902 acquires the organization name the target belongs to. The minutes providing unit 1902 determines whether the office organization, which the user belongs to, is equal to the office organization the target belongs to. The minutes providing unit 202 determines the target domain type. Next, the minutes providing unit 1902 calls the importance level evaluation unit 1904.

The importance level evaluation unit 204 acquires the weighted coefficient information illustrated in FIG. 5. The importance level evaluation unit 204 evaluates the importance level of the comment based on the weighted values included in the weighted coefficient information. Thus the minutes-of-meeting server 1814 evaluates the importance level of comment included in the minutes-of-meeting information.

In one embodiment of the invention, there is provided a non-transitory computer readable storage medium containing instructions which when executed on a computer or other specially programmed processor executes the following functions, comprising providing minutes-of meeting-information corresponding to a request for minutes of a meeting and evaluating a first importance level corresponding to a user who requests browsing of the minutes of meeting.

Moreover, the non-transitory computer readable storage medium can be programmed to perform any of the steps and functions described above.

In one embodiment of the invention, there is provided a system for information processing comprising an information providing unit which provides minutes-of-meeting information corresponding to a request for minutes of a meeting, and an importance level evaluation unit which evaluates a first importance level corresponding to a user who requests browsing of the minutes of the meeting.

Moreover, the system for information processing can be configured through its networking and programmed to perform any of the steps and functions described above.

Further, the present invention is not limited to the above-described embodiments, and variations and modifications may be made without departing from the basic concepts of the present invention as claimed.

What is claimed is:

1. An information processing apparatus which provides minutes-of-meeting information corresponding to a request for minutes of a meeting, comprising
an importance level evaluation unit which evaluates a first importance level corresponding to a user who requests browsing of the minutes of the meeting.

2. The apparatus as claimed in claim 1, wherein:
the importance level evaluation unit evaluates the first importance level based on 1) target identification information which identifies a target of a comment included in the minutes of meeting and 2) user identification information which identifies the user.

3. The apparatus as claimed in claim 2, wherein:
the importance level evaluation unit evaluates a second importance level of higher in importance than the first importance level in a case in which the target identification information is equal to the user identification information rather than in case in which the target identification information is not equal to the user identification information.

4. The apparatus as claimed in claim 2, further comprising;
an office organization information acquiring unit which acquires office organization information, which the target or the user belongs to, based on the target identification information or the user identification information, wherein
the importance level evaluation unit evaluates a second importance level higher in importance than the first importance level in a case in which the office organization information the target belongs to is equal to the office organization information the user belongs to rather than in a case in which the office organization information the target belongs to is not equal to the office organization information the user belongs to.

5. The apparatus as claimed in claim 1, wherein:
the importance level evaluation unit evaluates the first importance level based on a comment purpose indicator included in the minutes-of-meeting information.

6. The apparatus as claimed in claim 1, wherein:
the importance level evaluation unit evaluates the first importance level based on an appointment of a speaker of the minutes and a speaker comment included in the minutes-of-meeting information.

7. An information processing method for providing minutes-of-meeting information corresponding to a request for minutes of a meeting, comprising:
evaluating a first importance level corresponding to a user who requests browsing of the minutes of meeting.

8. The method as claimed in claim 7, wherein the evaluating comprises:
evaluating the importance level based on 1) target identification information which identifies a target of comment included in the minutes of meeting and 2) user identification information which identifies the user.

9. The method as claimed in claim 8, wherein the evaluating comprises:
evaluating a second importance level higher in importance than the first importance level in a case in which the target identification information is equal to the user identification information rather than in a case in which the target identification information is not equal to the user identification information.

10. The method as claimed in claim 8, further comprising;
acquiring office organization information, which the target or the user belongs to, based on the target identification information or the user identification information; and
evaluating a second importance level higher in importance than the first importance level in a case in which the office organization information the target belongs to is equal to the office organization information the user belongs to rather than in a case in which the office organization information the target belongs to is not equal to the office organization information the user belongs to.

11. The method as claimed in claim 7, wherein the evaluating comprises:
evaluating the first importance level based on a comment purpose indicator included in the minutes-of-meeting information.

12. The method as claimed in claim 7, wherein the evaluating comprises:
evaluating the first importance level based on an appointment of a speaker of the minutes and a speaker comment included in the minutes-of-meeting information.

13. A information processing apparatus comprising:
means for providing minutes-of-meeting information corresponding to a request for minutes of a meeting; and
means for evaluating a first importance level corresponding to a user who requests browsing of the minutes of meeting.

14. The apparatus as claimed in claim 13, wherein the means for evaluating comprise:
means for evaluating the importance level based on 1) target identification information which identifies a target of comment included in the minutes of meeting and 2) user identification information which identifies the user.

15. The apparatus as claimed in claim 13, wherein the means for evaluating comprise:
means for evaluating a second importance level higher in importance than the first importance level in a case in which the target identification information is equal to the user identification information rather than in a case in which the target identification information is not equal to the user identification information.

16. The apparatus as claimed in claim 13, further comprising;
means for acquiring office organization information, which the target or the user belongs to, based on the target identification information or the user identification information; and
means for evaluating a second importance level higher in importance than the first importance level in a case in which the office organization information the target belongs to is equal to the office organization information the user belongs to rather than in a case in which the office organization information the target belongs to is not equal to the office organization information the user belongs to.

17. The apparatus as claimed in claim 12, wherein the means for evaluating comprise:
means for evaluating the first importance level based on a comment purpose indicator included in the minutes-of-meeting information.

18. The apparatus as claimed in claim 12, wherein the means for evaluating comprise:
means for evaluating the first importance level based on an appointment of a speaker of the minutes and a speaker comment included in the minutes-of-meeting information.
